(19) United States
(12) Patent Application Publication
(10) Pub. No.: US 2009/0094606 A1
(43) Pub. Date: Apr. 9, 2009

(54) Method for fast XSL transformation on multithreaded environment

(75) Inventors: Peng-Sheng Chen, Tainan (TW); Fu-Shun Chu, Kaohsiung County (TW)

Correspondence Address: TROXELL LAW OFFICE PLLC, 5205 LEESBURG PIKE, SUITE 1404, FALLS CHURCH, VA, 22041, US

(73) Assignee: National Chung Cheng University, Chia-Yi (TW)

(21) Appl. No.: 11/905,782

(22) Filed: Oct. 4, 2007

(51) Int. Cl. G06F 9/46

(52) U.S. Cl. 718/100

(57) ABSTRACT

An XSLT method is used in a multi-thread environment. In the XSLT method, an XML file is analyzed in view of XSLT templates. Relationships between the transforming processes of the XSLT templates and the tree nodes of the XML file are built. Time for the execution of the transforming process of each of the XSLT templates and the number of a related one of the tree nodes are calculated. Threads are scheduled for the transforming processes of the XSLT templates. The transforming processes of the XSLT templates are executed.

### BACKGROUND OF INVENTION

1. Field of Invention

The present invention relates to an extensible style-sheet language transformation (“XSLT”) method in a multi-thread environment and, more particularly, to an XSLT based on the concept of parallel processing of data in a multi-thread processor to expedite the XSLT to satisfy the needs for extensible markup language (“XML”) data processing.

2. Related Prior Art

As the Internet and the World Wide Web (“WWW”) thrive, the storage, transmission, exchange and transformation of a huge number of data continue. There will be more and more needs for data processing. The XML is a language proposed to regulate the description of data by the World Wide Web Consortium. The XML has been widely used in personal data processing, e-commerce platforms, administration, database and the description of data in special fields. The XML is becoming more and more important in the international exchange and storage of data. From the angle of view of software, the XML enables software in different fields and on different platform to communicate. Through transformation, data described by the XML can satisfy the needs of different software.

The XSLT is a language for transforming XML data by picking from or re-configuring these data based on users' needs. In practice, there are two ways of executing the XSLT. The first way is interpretation. The second way is compiling. According to an investigation done by a famous XML application software company, Sarvega, the flow of the XML data has exceeded that of emails since the year of 2004. It has been predicted that the flow of the XML data will exceed that of the Web. In the near future, there will be a lot of XML data around us. A huge number of XML data will be exchanged, transformed and copied around the world through the Web or other media. Soon, we will have to ask ourselves one question, what should we do to process and transform so much XML data quickly and correctly. As an answer to this question, the present invention is intended to propose fast XSLT in a multi-thread environment.

### SUMMARY OF INVENTION

The primary objective of the present invention is to provide an XSLT method based on the concept of the parallel processing of data in a multi-thread processor to expedite the XSLT to satisfy the needs for XML data processing.

To fulfill the objective of the present invention, an XSLT method is used in a multi-thread environment. In the XSLT method, an XML file is analyzed in view of XSLT templates. Relationships between the transforming processes of the XSLT templates and the tree nodes of the XML file are built. Time for the execution of the transforming process of each of the XSLT templates and the number of a related one of the tree nodes are calculated. Threads are scheduled for the transforming processes of the XSLT templates. The transforming processes of the XSLT templates are executed.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a flowchart of an XSLT method according to the preferred embodiment of the present invention.

FIGS. 2 and 3 are block diagrams of a case for the application of the method shown in FIG. 1.

FIGS. 4 and 5 are block diagrams of another case for the application of the method shown in FIG. 1.

### DETAILED DESCRIPTION OF PREFERRED EMBODIMENTS

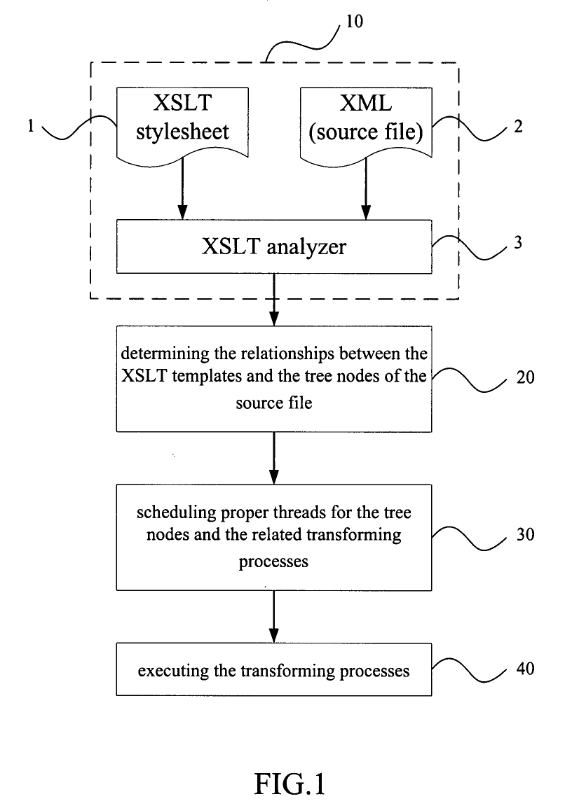

According to FIG. 1, there is shown an XSLT method according to the preferred embodiment of the present invention. The XSLT is used in a multi-thread environment.

At 10, XSLT style-sheets 1 and an XML file (“source file”) 2 are transferred to an XSLT analyzer 3 in which the source file 2 is analyzed in view of the XSLT style-sheets 1.

At 20, based on the analysis executed by the XSLT analyzer 3, the relationships between the transforming processes of the XSLT templates and the tree nodes of the source file 2. In the relationships, the periods of time for executing the transforming processes of the XSLT templates and the number of the tree nodes are learned.

At 30, according to the relationships between the transforming processes of the XSLT templates and the tree nodes of the source file 2, the prices for executing the transforming processes of the XSLT templates and the number of the tree nodes, the scheduling of proper threads is executed. The scheduling of the threads is closely related to hardware parameters such as the number of the cores of a processor. This is however not the spirit of the present invention, and reference can be drawn to the prior art, and therefore will not be described in detail.

At 40, the XSLT is executed.

As discussed above, the XSLT method satisfies the needs for the XML data processing by expediting the XSLT based on the concept of the parallel processing of data in a multi-thread processor. In the XSLT method, the XSLT templates are used to pick from or reconfigure the tree nodes of the source file. In the transformation, what XSLT templates used in what tree nodes are regulated according to corresponding XPath of the XSLT. Therefore, the tree nodes of the source file are related to some processing activities.

In the XSLT method, the XSLT templates and the source file are analyzed to obtain the processing activity related to each of the tree nodes. The transformation of each of the tree nodes is parallel to that of any other tree node. However, the output after the transformation must be executed in order. In the present invention, an output buffer zone can be used to solve this problem. All of the template matches are transferred into this buffer zone before they are transferred from this buffer zone in order according to regulations concerning the XSLT templates. Based on this information, the XSLT transformation can properly be assigned to different threads in the multi-thread environment.

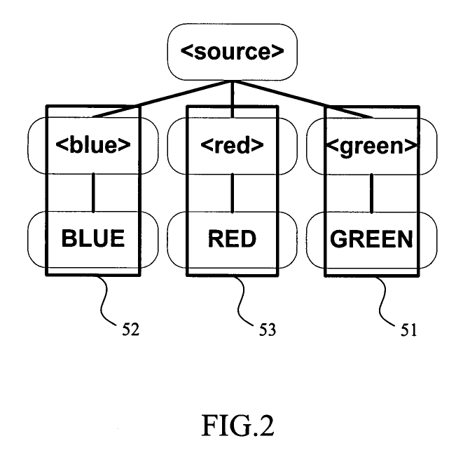

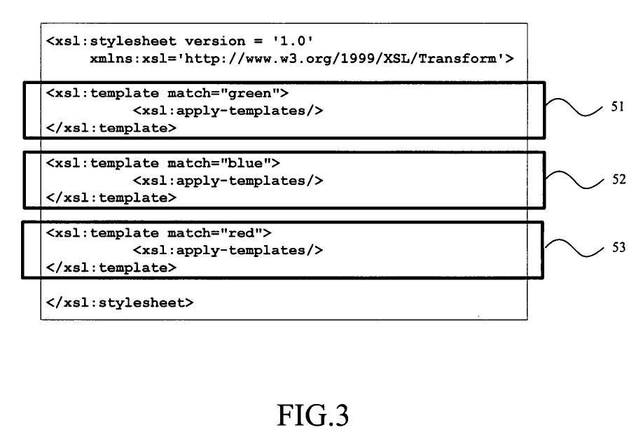

Referring to FIGS. 2 and 3, there is shown a case for applying the XSLT method according to the preferred embodiment of the present invention. The source file 2 includes the operation of three template matches 51, 52 and 53. The template matches are only applicable in different child trees. Therefore, the operation of the template matches 51, 52 and 53 can be synchronously executed and properly assigned to different threads.

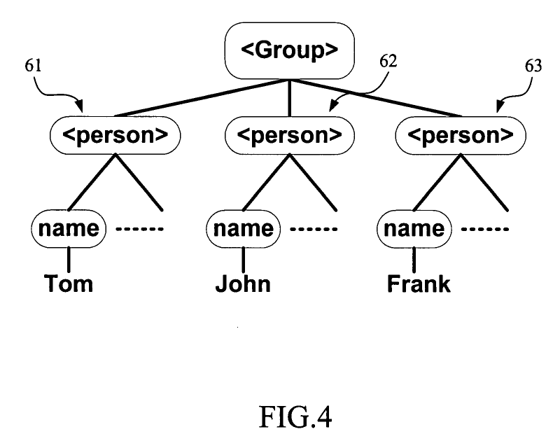

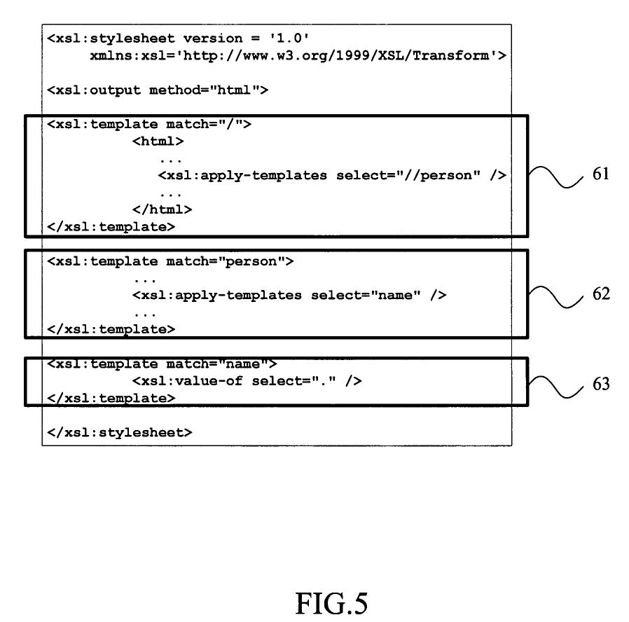

Referring to FIGS. 4 and 5, there is shown a case for applying the XSLT method according to the preferred embodiment of the present invention. The source file 2 includes three child trees 61, 62 and 63 under three personal tree nodes. Each of the child trees 61, 62 and 63 is related to a transforming process for a related one of the green, blue and red squares of the XSLT file. According to the concept of the parallel data processing, the child trees 61, 62 and 63 under the person tree nodes can be executed in parallel. A thread is assigned to the transforming process for each of the child trees 61, 62 and 63.

Moreover, the XSLT method can be applied in a Windows, COMMAND MODE or other environment.

The XSLT method solves the problems addressed in the RELATED PRIOR ART and satisfies the needs for the XML data processing by expediting the XSLT based on the concept of the parallel processing of data in a multi-thread processor.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An XSLT method in a multi-thread environment, the XSLT method comprising the steps of:
analyzing an XML file in view of XSLT templates;
building relationships between the transforming processes of the XSLT templates and the tree nodes of the XML file;
calculating the time needed for the execution of the transforming process of each of the XSLT templates and the number of a related one of the tree nodes;
scheduling threads for the transforming processes of the XSLT templates; and
executing the transforming processes of the XSLT templates.

2. The method according to claim 1, wherein the method is used in a Windows environment.

3. The method according to claim 1, wherein the method is used in a COMMAND MODE environment.
